(19) United States
(12) Patent Application Publication
(10) Pub. No.: US 2023/0063478 A1
(43) Pub. Date: Mar. 2, 2023

(54) SIMULATION METHOD, SIMULATION DEVICE, AND NON-TRANSITORY COMPUTER READABLE MEDIUM STORING PROGRAM

(71) Applicant: SUMITOMO HEAVY INDUSTRIES, LTD., Tokyo (JP)

(72) Inventor: Yoshitaka Ohnishi, Kanagawa (JP)

(21) Appl. No.: 17/881,267

(22) Filed: Aug. 4, 2022

(30) Foreign Application Priority Data
Sep. 2, 2021 (JP) 2021-143071

(51) Int. Cl. G06F 30/25; G06F 30/23; G06T 17/20

(52) U.S. Cl. CPC G06F 30/25; G06F 30/23; G06T 17/205; G06T 2210/56

(57) ABSTRACT

To provide a simulation method in which a zooming analysis method is applied to a particle method to analyze displacement and stress.

An analysis model in which an object to be analyzed is divided by a first mesh is analyzed by using a finite element method or a particle method. A partial region of the analysis model is selected as a zooming region, the zooming region is divided by a second mesh, and a particle is disposed at each node of the second mesh. The particle at the node is displaced based on displacement by the analysis using the first mesh. A boundary condition of the zooming region is set based on a particle position at the node after the displacement. The particle is displaced by using the particle method under the boundary condition. Stress acting on the zooming region is obtained based on a particle position after the displacement.

### RELATED APPLICATIONS

The content of Japanese Patent Application No. 2021-143071, on the basis of which priority benefits are claimed in an accompanying application data sheet, is in its entire incorporated herein by reference.

### BACKGROUND

### Technical Field

A certain embodiment of the present invention relates to a simulation method, a simulation device, and a non-transitory computer readable medium storing a program.

### Description of Related Art

A finite element method is used to analyze deformation and stress of a structure. The related art discloses a zooming analysis method used to suppress an increase in calculation time and improve a resolution. In the zooming analysis, first, the analysis of the deformation and stress by using the finite element method is performed on an analysis model in which a structure to be analyzed is divided by a coarse mesh. Further, a zooming region, which is a partial region of the analysis model, is divided by a fine mesh and a boundary condition is set for the zooming region to analyze the deformation and stress of the zooming region.

An analysis result of the analysis model divided by the coarse mesh is passed to the analysis of the zooming region divided by the fine mesh, and in the analysis of the zooming region divided by the fine mesh, only the zooming region is analyzed without analyzing the entire structure. Therefore, a calculation load is reduced and the resolution of the analysis of the zooming region is improved.

### SUMMARY

According to one aspect of the invention, there is provided a simulation method including
performing an analysis using a finite element method or a particle method on an analysis model in which an object to be analyzed is divided by a first mesh,
selecting a partial region of the analysis model as a zooming region, dividing the zooming region by a second mesh finer than the first mesh, and disposing a particle at each of a plurality of nodes of the second mesh,
displacing the particle disposed at the node of the second mesh based on displacement obtained by the analysis using the first mesh,
setting a boundary condition of the zooming region based on a position of the particle disposed at the node of the second mesh after the displacement,
displacing the particle using the particle method under the boundary condition in the zooming region, and
obtaining stress acting on the zooming region based on a position of the particle after the particle in the zooming region is displaced by using the particle method.

According to another aspect of the invention, there is provided a simulation device including
an input unit that receives an analysis condition for an object to be analyzed,
a processing unit that performs an analysis of the object to be analyzed based on the analysis condition input to the input unit, and
an output unit that outputs an analysis result of the processing unit.
The processing unit
divides an analysis model input to the input unit by a first mesh to perform the analysis using a finite element method or a particle method,
selects a partial region of the analysis model as a zooming region, divides the zooming region by a second mesh finer than the first mesh, and disposes a particle at each of a plurality of nodes of the second mesh,
displaces the particle disposed at the node of the second mesh based on displacement obtained by the analysis using the first mesh,
sets a boundary condition of the zooming region based on a position of the particle disposed at the node of the second mesh after the displacement,
displaces the particle using the particle method under the boundary condition in the zooming region,
obtains stress acting on the zooming region based on a position of the particle after the particle in the zooming region is displaced by using the particle method, and
outputs the analysis result of the stress acting on the zooming region to the output unit.

According to yet another aspect of the invention, there is provided a non-transitory computer readable medium storing a program that causes a computer to realize functions including
acquiring an analysis condition,
dividing an analysis model by a first mesh based on the acquired analysis condition to perform an analysis using a finite element method or a particle method,
selecting a partial region of the analysis model as a zooming region, dividing the zooming region by a second mesh finer than the first mesh, and disposing a particle at each of a plurality of nodes of the second mesh,
displacing the particle disposed at the node of the second mesh based on displacement obtained by the analysis using the first mesh,
setting a boundary condition of the zooming region based on a position of the particle disposed at the node of the second mesh after the displacement,
displacing the particle using the particle method under the boundary condition in the zooming region,
obtaining stress acting on the zooming region based on a position of the particle after the particle in the zooming region is displaced by using the particle method, and
outputting the analysis result of the stress acting on the zooming region.

### BRIEF DESCRIPTION OF THE DRAWINGS

FIGS. 1A and 1B are perspective views of an example of an object for which deformation and stress are analyzed by simulation.

FIG. 2 is a flowchart showing a procedure of a simulation method according to an example.

FIGS. 3A and 3B are perspective views of a state in which each of a first member and a second member is divided by a first mesh, and FIG. 3C is a perspective view of the first mesh in a state in which the second member is inserted into the first member.

FIG. 4A is a plan view of the first mesh of an analysis model in an initial state, and FIG. 4B is a plan view of the first mesh of the analysis model in a balanced state.

FIG. 5A is a schematic diagram showing a relative positional relationship between a plurality of first particles and one second particle in an initial state before executing step S03, and FIG. 5B is a schematic diagram showing the relative positional relationship between the plurality of first particles and one second particle in a state after executing step S03 to displace the first particle.

FIG. 6A is a schematic diagram showing a positional relationship between the first particles and second particles before displacement, and FIG. 6B is a schematic diagram showing the positional relationship between the first particles and the second particles after the displacement.

FIG. 7 is a schematic diagram showing second particles located on a surface of a zooming region (first member) among the second particles after the displacement.

FIG. 8 is a schematic diagram showing a relative positional relationship between the zooming region, a polygon wall, and the second particles.

FIGS. 9A and 9B are views representing distributions of stress calculated based on a displacement amount of the first particle obtained in step S03 and stress calculated based on a displacement amount of the second particle in step S12 by shades of color.

FIG. 10A is a view representing the distribution of the stress calculated based on the displacement amount of the first particle obtained in step S03 by shades of color, and

FIG. 10B is a view representing a distribution of stress calculated based on a position of the second particle displaced in step S06 by shades of color.

FIG. 11 is a block diagram of a simulation device according to the present example.

### DETAILED DESCRIPTION

A particle method may be used as a method of analyzing the deformation and stress of the structure. For example, in performing an analysis of a case where a plurality of members are displaced from a state in which the members are separated from each other to a state in which the members are in contact with each other, or a state in which a plurality of members are in contact with each other and exert forces on each other, a calculation using the particle method can be made without failure compared with the calculation using the finite element method in many cases. Examples of the particle method to be applied include a moving particle semi-implicit (MPS) method, a smoothed particle hydrodynamics (SPH) method, and a renormalization molecular dynamics (RMD) method.

Using the zooming analysis method, each particle is disposed at a node of the fine mesh in the zooming region and the analysis result of the coarse mesh is passed to each particle to obtain a stress distribution. Irregular unevenness (mottled pattern) is found to occur in the stress distribution. Therefore, the zooming analysis method in the related art cannot be applied to the particle method. This is because the particle method is not a method of obtaining the stress from the displacement of each particle, but a method based on an interaction between particles.

According to an embodiment of the present invention, there is provided a simulation method, a simulation device, and a non-transitory computer readable medium storing a program that perform an analysis of displacement and stress by applying a zooming analysis method to a particle method.

The particle disposed at the node of the second mesh is displaced based on the displacement obtained by the analysis using the first mesh, then the particle is displaced by using the particle method under the boundary condition in the zooming region before the stress in the zooming region is obtained, and thus it is possible to obtain the stress distribution without the irregular unevenness.

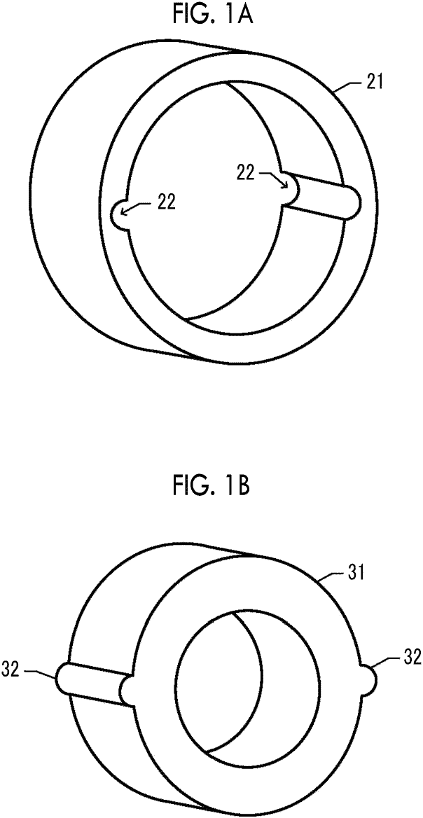

A simulation method according to an example will be described with reference to drawings from FIG. 1A to 11.

FIGS. 1A and 1B are perspective views of an example of an object for which deformation and stress are analyzed by simulation. The object to be analyzed includes two members. Each of the two members has a substantially ring-shaped outer shape. An inner diameter of one first member 21 is substantially equal to an outer diameter of the other second member 31. Two grooves 22 extending in a direction orthogonal to a circumferential direction are provided on an inner peripheral surface of the first member 21. Two protrusions 32 extending in a direction orthogonal to a circumferential direction are provided on an outer peripheral surface of the second member 31. The second member 31 is inserted into the first member 21 such that the protrusion 32 is fitted into the groove 22. In the simulation according to the example, a stress distribution in a state in which the second member 31 is inserted into the first member 21 is obtained.

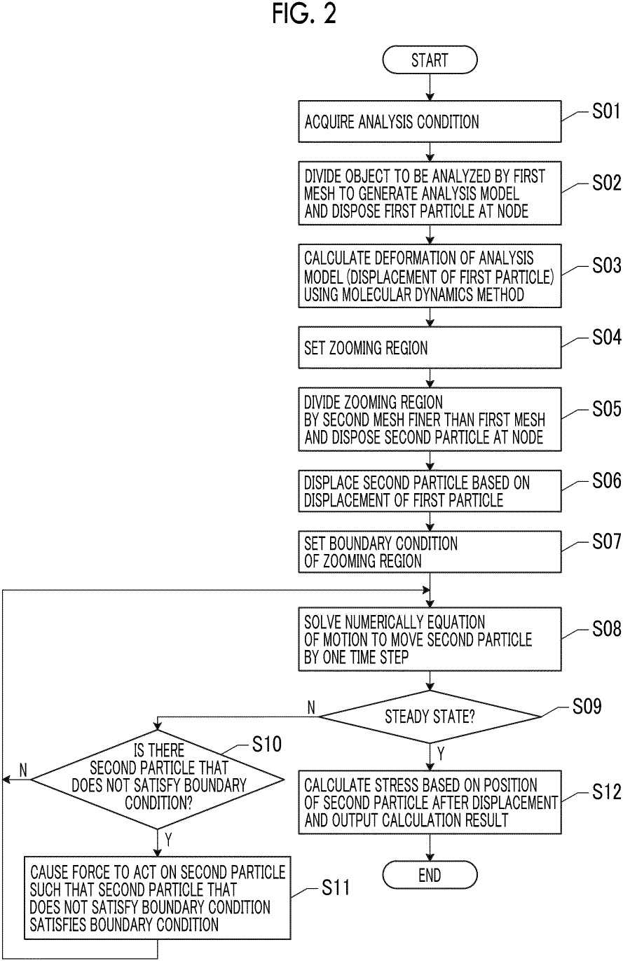

FIG. 2 is a flowchart showing a procedure of the simulation method according to the example.

First, an analysis condition is acquired (step S01). The analysis condition includes a geometric shape, Young’s modulus, Poisson’s ratio, and density of the object to be analyzed, a load condition acting on the object to be analyzed, and the like. In a case where the geometric shape of the object to be analyzed is determined, an analysis model in which the object to be analyzed is divided by a first mesh is generated, and a first particle is disposed at a node of the first mesh (step S02).

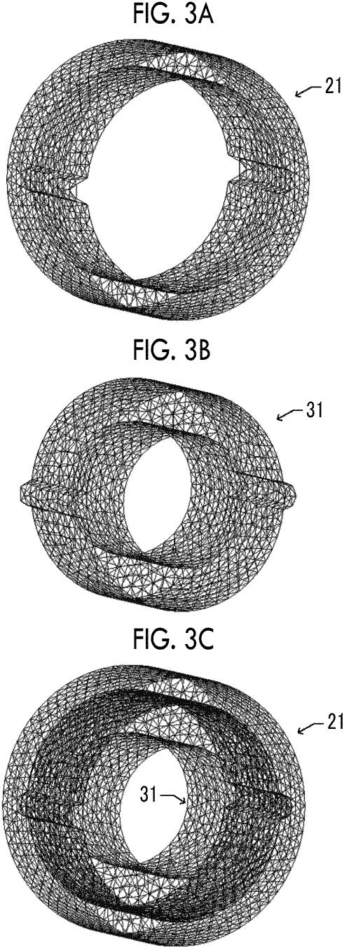

FIGS. 3A and 3B are perspective views of a state in which each of the first member 21 (FIG. 1A) and the second member 31 (FIG. 1B) is divided by the first mesh. FIG. 3C is a perspective view of the first mesh in a state in which the second member 31 is inserted into the first member 21, and a structure in this state is used as the analysis model. A particle is disposed at each node of the first mesh of the analysis model shown in FIG. 3C.

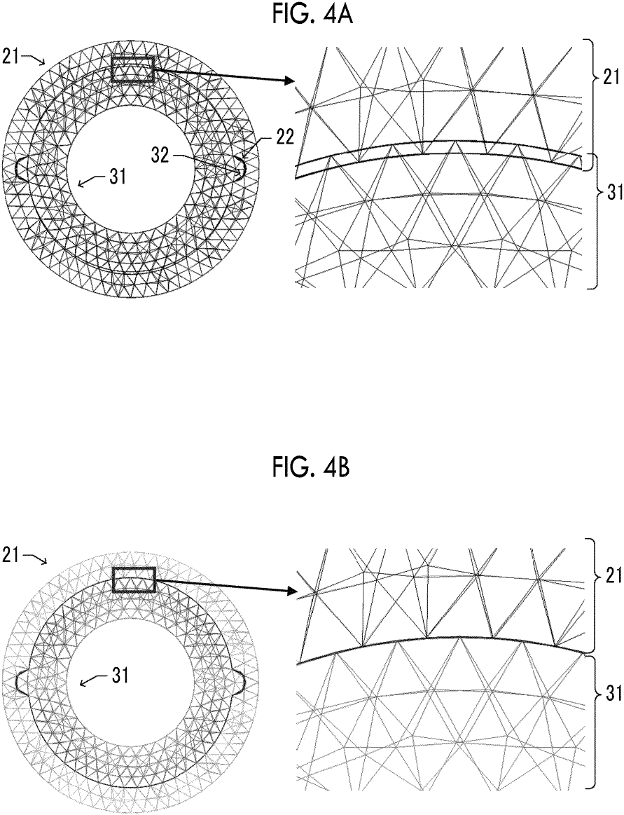

FIG. 4A is a plan view of the first mesh of the analysis model in an initial state. A left side of FIG. 4A shows an overall view of the first mesh of the analysis model, and a right side thereof shows an enlarged view of a part of a contact interface between the first member 21 and the second member 31. The second member 31 is inserted into the first member 21, and the protrusion 32 of the second member 31 is fitted into the groove 22 of the first member 21. In the initial state, the inner peripheral surface of the first member 21 bites inward from the outer peripheral surface of the second member 31.

The state shown in FIG. 4A cannot be realized in reality, and the analysis using the RMD method is performed with this state as the initial state to obtain a state in which the first member 21 and the second member 31 are balanced. Specifically, the equation of motion is numerically solved for each of first particles, and the first particles are displaced until a balanced state (steady state) is reached (step S03). In a case where the equation of motion is solved, a mass of the particle and an interaction between particles are set based on physical property values (density, Young’s modulus, and the like) of the first member 21 and the second member 31. In a case where a displacement amount when the first particle is displaced by one time step by solving the equation of motion is substantially zero, determination may be made that the steady state is reached.

FIG. 4B is a plan view of the first mesh of the analysis model in the steady state. A left side of FIG. 4B shows an overall view of the first mesh of the analysis model, and a right side thereof shows an enlarged view of a part of the contact interface between the first member 21 and the second member 31. It can be seen that the first member 21 and the second member 31 are deformed (the first particle is displaced), and the inner peripheral surface of the first member 21 substantially matches the outer peripheral surface of the second member 31. That is, the inner peripheral surface of the first member 21 and the outer peripheral surface of the second member 31 are in contact with each other and balanced.

Next, a zooming region is set (step S04). In the present example, the entire first member 21 is set as the zooming region. The second member 31 is not selected as the zooming region.

After the zooming region is set, the zooming region, that is, the first member 21 is divided by a second mesh finer than the first mesh, and a second particle is disposed at each node of the second mesh (step S05). In this case, the first member 21 divided by the second mesh is in the initial state before the deformation in step S03.

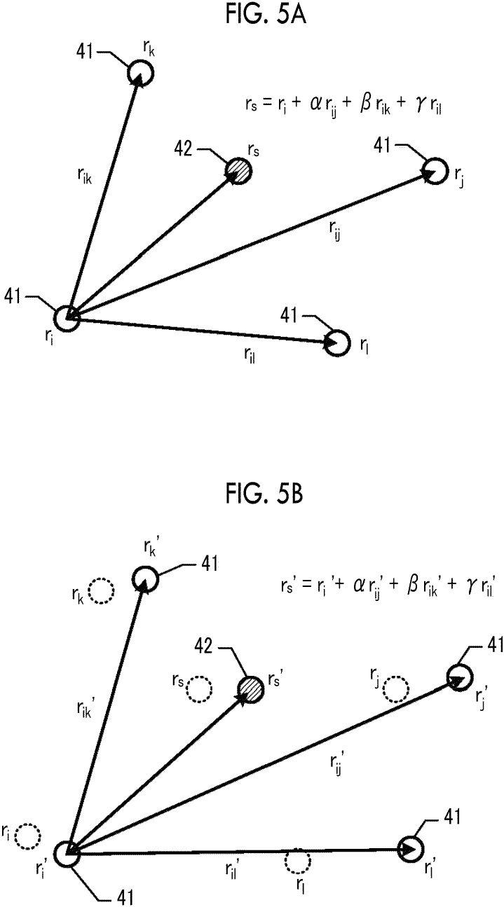

After the zooming region is divided by the second mesh, all second particles are displaced based on the displacement of the first particle obtained in step S03 (step S06). Hereinafter, a method of displacing the second particle will be described with reference to FIGS. 5A and 5B.

FIG. 5A is a schematic diagram showing a relative positional relationship between a plurality of first particles 41 and one second particle 42 in the initial state before executing step S03. Four first particles 41 near the second particle 42 are selected. In this case, the four first particles 41 are selected under a condition that the four first particles 41 are not located on the same plane. For example, the four first particles 41 are selected such that the second particles 42 are included in a tetrahedron having the four first particles 41 as vertices.

A position vector of the second particle 42 is marked as rₛ, and position vectors of the four first particles 41 are marked as rᵢ, rⱼ, rₖ, and rₗ, respectively. A vector whose start point is a position rᵢ and whose end point is a position rⱼ is marked as rᵢⱼ. That is, rᵢⱼ = rⱼ - rᵢ. The position vector rₛ of the second particle 42 is defined by the following equation.

$${\text{r}}_{\text{s}} = {\text{r}}_{\text{i}} + α {\text{r}}_{\text{ij}} + β {\text{r}}_{\text{ik}} + γ {\text{r}}_{\text{il}}$$

The positions of the first particle 41 and the second particle 42 in the initial state are known. From these positions, values of coefficients α, β, and γ in equation (1) can be determined. The values of the coefficients α, β, and γ are determined for each second particle 42.

FIG. 5B is a schematic diagram showing the relative positional relationship between the plurality of first particles 41 and one second particle 42 in a state after executing step S03 to displace the first particle 41. In FIG. 5B, the first particle 41 and the second particle 42 before the displacement are shown by broken lines. The position vectors of the first particles 41 at the positions rᵢ, rⱼ, rₖ, and rₗ after the displacement are marked as r_{i'}, r_{j'}, r_{k'}, and r_{l'}, respectively. The position vector of the second particle 42 after the displacement in step S06 is marked as r_{s'}. The second particle 42 is displaced such that the position vector r_{s'} satisfies the following equation.

$${\text{r}}_{\text{s}} {}^{′} = {\text{r}}_{\text{i}} {}^{′} + α {\text{r}}_{\text{ij}} {}^{′} + β {\text{r}}_{\text{ik}} {}^{′} + γ {\text{r}}_{\text{il}} {}^{′}$$

Values of coefficients α, β, and γ of equation (2) are the same as the values of the coefficients α, β, and γ of equation (1).

In the initial state, the second particle 42 disposed at the same position as the first particle 41 may be displaced by the same displacement amount in the same direction as the first particle 41.

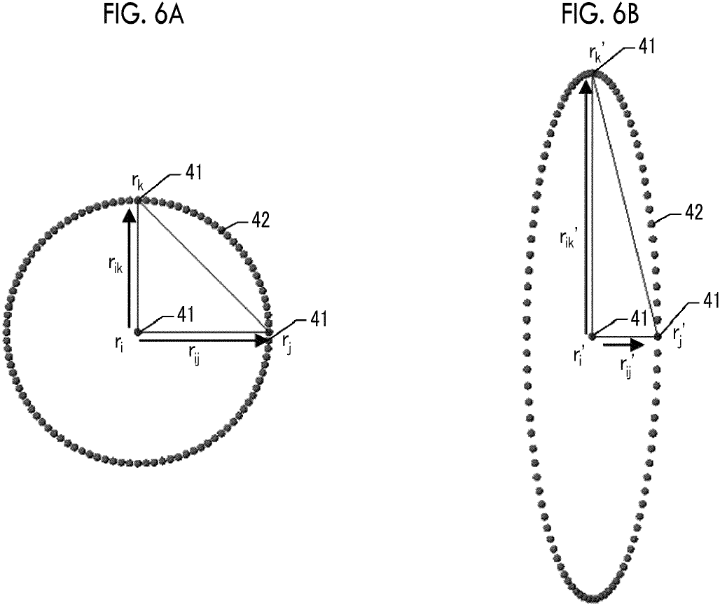

Next, an example of the relative positional relationships before and after the displacement of the first particle 41 and the second particle 42 distributed in two dimensions will be described with reference to FIGS. 6A and 6B.

FIG. 6A is a schematic diagram showing the positional relationship between three first particles 41 and a plurality of second particles 42 before the displacement. The three first particles 41 are disposed at the positions rᵢ, rⱼ, and rₖ corresponding to three vertices of an isosceles right triangle, respectively. The plurality of second particles 42 are disposed along a circumference whose center is a right-angled vertex of the isosceles right triangle and whose radius is a length of two sides sandwiching the right angle.

FIG. 6B is a schematic diagram showing the positional relationship between the three first particles 41 and the plurality of second particles 42 after the displacement. The first particles 41 at the positions rᵢ, rⱼ, and rₖ are displaced to the positions r_{l'}, r_{j'}, and r_{k'}, respectively. The positions r_{i'}, r_{j'}, and r_{k'} after the displacement are located at vertices of an unequal-sided right triangle. The position r_{i'}, corresponds to the right-angled vertex. The vector r_{ij'} after the displacement is shorter than the vector rᵢⱼ before the displacement, and the vector r_{ik'} after the displacement is longer than the vector rᵢₖ before the displacement.

In a case where the second particles 42 are displaced such that equation (2) is satisfied based on the displacement of the first particles 41, the second particles 42 after the displacement are distributed along a long circumference obtained by crushing the circumference in a direction of the vector rᵢⱼ and stretching the circumference in a direction of the vector rᵢₖ. This displacement reflects the displacement of a typical member. It can be considered that the displacement of the second particles 42 such that equation (2) is satisfied in this manner sufficiently reflects the displacement of the typical member.

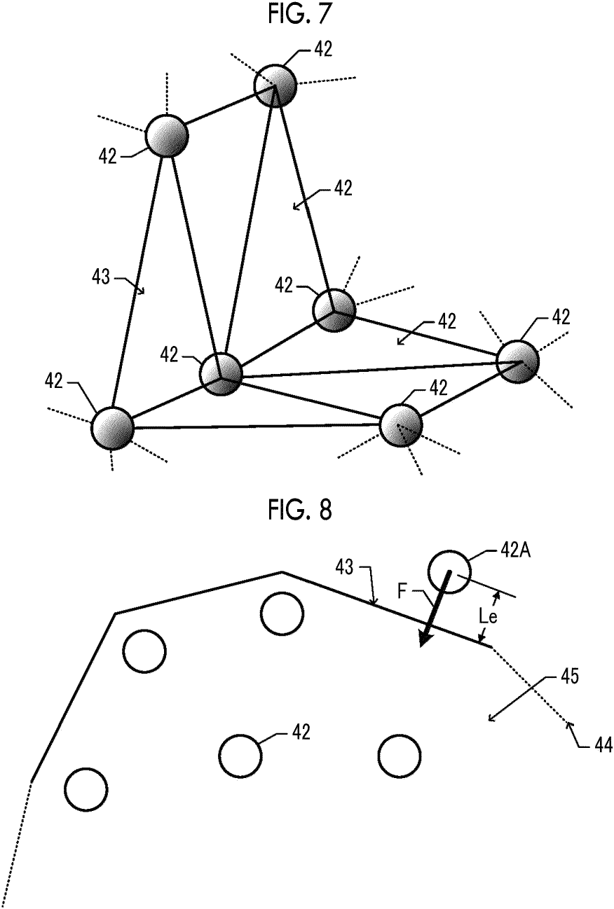

After the second particle is displaced in step S06 of FIG. 2, a boundary condition of the zooming region is set (step S07). Hereinafter, the boundary condition of the zooming region will be described with reference to FIG. 7.

FIG. 7 is a schematic diagram showing the second particles 42 located on a surface of the zooming region (first member 21) among the second particles after the displacement. A polygon wall composed of a plurality of polygon elements 43 with positions of the plurality of second particles 42 located on the surface of the zooming region as vertices is determined. The polygon wall matches a surface shape of the first member 21 after the deformation. Each of the polygon elements 43 is, for example, a triangular element with the position of the second particle 42 as the vertex. In a case where the second particle 42 is displaced in a next step, a position of this polygon wall is fixed in an analysis space. As the boundary condition of the zooming region, a condition that the second particle 42 does not protrude from the polygon wall is imposed by causing a force of pulling back inward from the polygon wall to act on the second particle 42 displaced outside the polygon wall.

Next, the equation of motion is numerically solved for each of the plurality of second particles 42 to move the second particle 42 by one time step (step S08). In this case, it is preferable to reduce the number of time steps until the steady state is reached by dissipating energy in consideration of a dissipative force that attenuates vibration inside a particle system and a viscous force that attenuates a translational motion of the particle system. As a method of dissipating the energy, for example, a method described in Japanese Unexamined Patent Publication No. 2011-233115 may be used.

Every time the second particle 42 is moved by solving the equation of motion, determination is made whether or not the steady state (balanced state) is reached (step S09). In a case where the steady state is reached, the stress acting on the zooming region is calculated based on the position of the second particle after the displacement, and a calculation result is output (step S12).

In a case where the steady state is not reached, determination is made whether or not there is a second particle that does not satisfy the boundary condition set in step S07 (step S10). That is, determination is made whether or not there is a second particle protruding outside the polygon wall. In a case where there is no second particle that does not satisfy the boundary condition, the processes of steps S08 to S09 are repeated. In a case where there is a second particle that does not satisfy the boundary condition, a force acts on the second particle that does not satisfy the boundary condition such that the boundary condition is satisfied (step S11).

The force acting on the second particle that does not satisfy the boundary condition will be described with reference to FIG. 8.

FIG. 8 is a schematic diagram showing a relative positional relationship between a zooming region 45, a polygon wall 44, and the second particles 42. The polygon wall 44 forms a surface of the zooming region 45. The plurality of second particles 42 are disposed in the zooming region 45. FIG. 8 shows an example in which one second particle 42A protrudes to the outside of the polygon wall 44 in a case where the second particle 42 is moved by solving the equation of motion in step S08. A distance from the polygon wall 44 to the second particle 42A is marked as Le.

In step S11, a force F in a direction of pulling back to the inside of the polygon wall 44 acts on the second particle 42A. The direction of the force F is perpendicular to the polygon element 43 closest to the second particle 42A, and the magnitude of the force F is proportional to the distance Le. In a case where the equation of motion is solved in step S08, the force F is additionally applied to the second particle 42A.

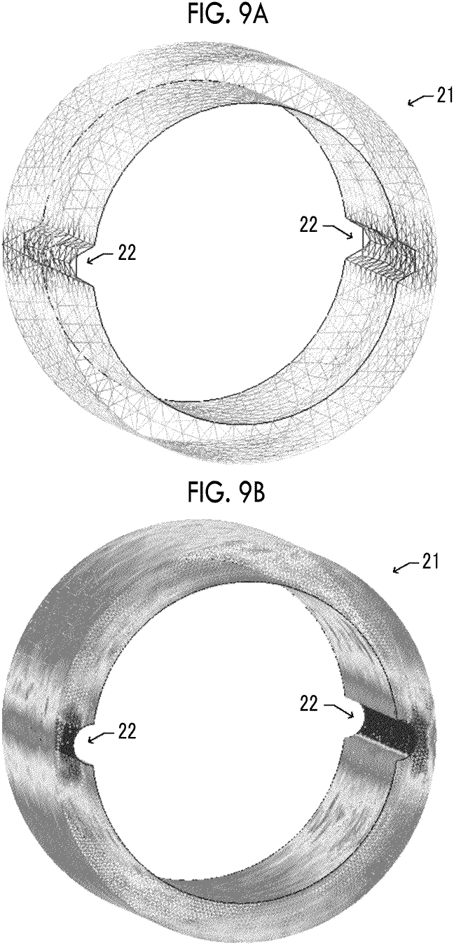

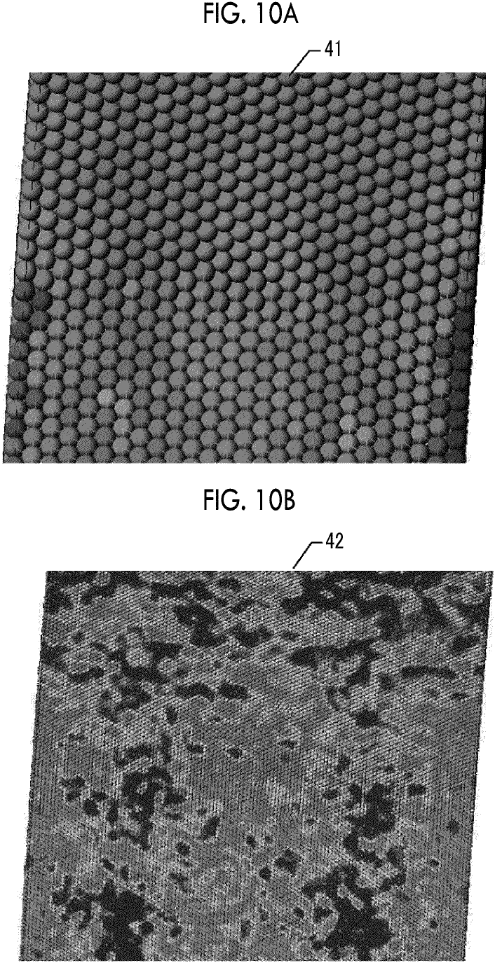

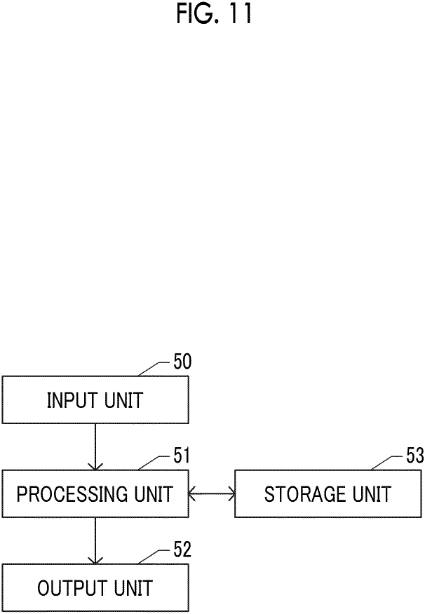

Next, excellent effects of the above-mentioned example will be described with reference to FIGS. 9A to 10B.

FIGS. 9A and 9B are views representing distributions of stress calculated based on the displacement amount of the first particle obtained in step S03 and stress calculated based on the displacement amount of the second particle in step S12 by shades of color. In FIGS. 9A and 9B, the darker the color, the greater the stress. With the use of the simulation method according to the present example, it can be seen that the stress distribution is obtained with higher resolution than the stress distribution obtained by dividing by the first mesh (FIG. 9A).

FIG. 10A is a view representing the distribution of the stress calculated based on the displacement amount of the first particle 41 obtained in step S03 by shades of color, and FIG. 10B is a view representing a distribution of stress calculated based on the position of the second particle 42 displaced in step S06 by shades of color. FIGS. 10A and 10B represent the stress distribution at the same location of the first member 21. Irregular unevenness that is not represented in FIG. 10A appears in the stress distribution shown in FIG. 10B. From this result, it can be seen that a desired stress distribution cannot be obtained only by displacing the second particle in step S06.

On the contrary, in a case where the stress is calculated in a state in which the steady state is reached by repeating the processes of solving the equation of motion in steps S08 to S11, a stress distribution in which the irregular unevenness does not appear can be obtained as shown in FIG. 9B. As described above, in the simulation method according to the above example, the displacement of the first particle at the node of the coarse first mesh is inherited by the second particle at the node of the fine second mesh, then the second particle is displaced until the steady state is reached by solving the equation of motion, and thus it is possible to eliminate the irregular unevenness in the stress distribution.

In other words, it is considered that the position of the second particle is not reached the steady state only by inheriting the displacement of the first particle at the node of the coarse first mesh to the second particle at the node of the fine second mesh. In the above example, the displacement amount of the first particle is inherited by the second particle, then the equation of motion is further solved for the second particle, and thus it is possible to obtain the stress distribution in the state in which the steady state is reached.

Further, in the above example, it is possible to reduce a calculation load as compared with the case where both the first member 21 and the second member 31 are divided by the fine second mesh for the analysis.

Next, a simulation device according to the example will be described with reference to FIG. 11.

FIG. 11 is a block diagram of the simulation device according to the present example. The simulation device according to the present example includes an input unit 50, a processing unit 51, an output unit 52, and a storage unit 53. The analysis condition and the like are input to the input unit 50. Further, various commands are input from a user to the input unit 50. The input unit 50 is configured of, for example, a communication device, a removable media reader, a keyboard, and a pointing device. The output unit 52 includes a communication device, a removable media writing device, a display, and the like.

The processing unit 51 executes the simulation according to the flowchart shown in FIG. 2 based on the input analysis condition and command. For example, in step S01, the processing unit 51 acquires the analysis condition input to the input unit 50. In step S12, the processing unit 51 outputs the calculation result to the output unit 52. The analysis result includes information indicating the distribution of stress acting on the object to be analyzed and the like. As an example, as shown in FIG. 9B, a figure representing the stress distribution by shades of color is displayed. The processing unit 51 includes, for example, a central processing unit (CPU) of a computer. A non-transitory computer readable medium storing a program that causes the computer to execute the simulation according to the example is stored in the storage unit 53.

Next, a modification example of the above example will be described.

In the above example, the structure in which the first member 21 and the second member 31 are in contact is an object to be analyzed, but it is also possible to obtain the deformation and stress distribution of another structure. Further, in the above example, the zooming region set in step S04 (FIG. 2) is matched with the region in the first member 21, but another region may be set as the zooming region. For example, a region near the groove 22 in the first member 21 may be set as the zooming region.

In the above example, equation (2) is used as the method of passing the displacement of the first particle to the second particle in step S06, but another method may be used. For example, it is preferable to displace the second particle such that the displacement of the first particle located near the second particle to be displaced is reflected in the displacement of the second particle.

In the above example, the first particle disposed at the node of the first mesh is displaced by using the RMD method in step S03, but other particle methods such as the MPS method and the SPH method may be applied to displace the first particle. Further, the finite element method may be applied to the first mesh to deform the first mesh. In this case, in step S06, the second particle disposed at the node of the second mesh may be displaced based on the displacement of the node of the first mesh after the deformation.

In the above example, the second particle is displaced by using the RMD method in step S08, but other particle methods such as the MPS method or the SPH method may be applied to displace the second particle.

The above examples are exemplifications, and the present invention is not limited to the above examples. For example, it will be obvious to those skilled in the art that various changes, improvements, combinations, and the like are possible.

It should be understood that the invention is not limited to the above-described embodiment, but may be modified into various forms on the basis of the spirit of the invention. Additionally, the modifications are included in the scope of the invention.

What is claimed is:

1. A simulation method comprising:
performing an analysis using a finite element method or a particle method on an analysis model in which an object to be analyzed is divided by a first mesh;
selecting a partial region of the analysis model as a zooming region, dividing the zooming region by a second mesh finer than the first mesh, and disposing a particle at each of a plurality of nodes of the second mesh;
displacing the particle disposed at the node of the second mesh based on displacement obtained by the analysis using the first mesh;
setting a boundary condition of the zooming region based on a position of the particle disposed at the node of the second mesh after the displacement;
displacing the particle using the particle method under the boundary condition in the zooming region; and
obtaining stress acting on the zooming region based on a position of the particle after the particle in the zooming region is displaced by using the particle method.

2. The simulation method according to claim 1,
wherein the analysis model is obtained by modeling a plurality of members that exert forces on each other, and
the zooming region matches a region obtained by modeling one member of the plurality of members.

3. The simulation method according to claim 2,
wherein the boundary condition includes a condition that a position of a polygon element of the second mesh constituting a surface of the zooming region is fixed in an analysis space.

4. The simulation method according to claim 3,
wherein in the zooming region, in a case where the particle is displaced by using the particle method under the boundary condition, a force of pulling back to an inside of a region surrounded by the fixed polygon element of the second mesh acts on a particle protruded outside the region surrounded by the polygon element of the second mesh.

5. A simulation device comprising:
an input unit that receives an analysis condition for an object to be analyzed;
a processing unit that performs an analysis of the object to be analyzed based on the analysis condition input to the input unit; and
an output unit that outputs an analysis result of the processing unit,
wherein the processing unit
divides an analysis model input to the input unit by a first mesh to perform the analysis using a finite element method or a particle method,
selects a partial region of the analysis model as a zooming region, divides the zooming region by a second mesh finer than the first mesh, and disposes a particle at each of a plurality of nodes of the second mesh,
displaces the particle disposed at the node of the second mesh based on displacement obtained by the analysis using the first mesh,
sets a boundary condition of the zooming region based on a position of the particle disposed at the node of the second mesh after the displacement,
displaces the particle using the particle method under the boundary condition in the zooming region,
obtains stress acting on the zooming region based on a position of the particle after the particle in the zooming region is displaced by using the particle method, and
outputs the analysis result of the stress acting on the zooming region to the output unit.

6. A non-transitory computer readable medium storing a program that causes a computer to realize functions comprising:
acquiring an analysis condition;
dividing an analysis model by a first mesh based on the acquired analysis condition to perform an analysis using a finite element method or a particle method;
selecting a partial region of the analysis model as a zooming region, dividing the zooming region by a second mesh finer than the first mesh, and disposing a particle at each of a plurality of nodes of the second mesh;
displacing the particle disposed at the node of the second mesh based on displacement obtained by the analysis using the first mesh;
setting a boundary condition of the zooming region based on a position of the particle disposed at the node of the second mesh after the displacement;
displacing the particle using the particle method under the boundary condition in the zooming region;
obtaining stress acting on the zooming region based on a position of the particle after the particle in the zooming region is displaced by using the particle method; and
outputting the analysis result of the stress acting on the zooming region.
